(19) United States
(12) Patent Application Publication
(10) Pub. No.: US 2021/0305933 A1
(43) Pub. Date: Sep. 30, 2021

(54) Systems For Cleaning And Analysis of NonPorous Surfaces

(71) Applicant: Christopher Escobedo, Phoenix, AZ (US)

(72) Inventor: Christopher Escobedo, Phoenix, AZ (US)

(21) Appl. No.: 17/198,169

(22) Filed: Mar. 10, 2021

Related U.S. Application Data
(60) Provisional application No. 62/987,821, filed on Mar. 10, 2020.

(51) Int. Cl. H02S 40/10; H02S 40/38; H02S 30/10; B08B 1/00; B08B 1/04; B08B 13/00; A46B 13/02; A46B 13/00; B25J 11/00; B25J 5/00; F24S 40/20; G05D 1/02

(52) U.S. Cl. CPC H02S 40/10; B60S 1/62; H02S 30/10; B08B 1/002; B08B 1/008; B08B 1/04; B08B 13/00; A46B 13/02; A46B 13/001; B25J 11/0085; B25J 5/007; F24S 40/20; G05D 1/0285; G05D 1/0278; G05D 1/0225; A46B 2200/3073; G05D 2201/0203; H02S 40/38

(57) ABSTRACT

Implementations of a solar panel cleaning system may include an extrusion frame; a driver end coupled to a first side of the extrusion frame; a battery end coupled to a second side of the extrusion frame; a solar panel coupled to a largest planar surface formed by the extrusion frame, the solar panel electrically coupled with a battery included in the battery end, the battery electrically coupled with one or more motors and with a controller included in the driver end; and one or more brushes coupled between the driver end and the battery end, an end of the one or more brushes coupled with the one or more motors. The driver end and the battery end may be configured to couple with one of a track that extends on either side of one or more solar panels or with edges of the one or more solar panels.

### CROSS REFERENCE TO RELATED APPLICATIONS

This document claims the benefit of the filing date of U.S. Provisional Patent Application 62/987,821, entitled “System For Cleaning And Analysis of Nonporous Surfaces,” to Christopher Escobedo which was filed on Mar. 10, 2020, the disclosure of which is hereby incorporated entirely herein by reference.

### BACKGROUND

### 1. Technical Field

Aspects of this document relate generally to systems for washing surfaces. More specific implementations involve systems for washing solar panels.

### 2. Background

Various systems exist that have been designed to clean surfaces. Squeegees have been used to clean glass surfaces. Wiper blades and oscillating motor control systems have been employed to clean vehicle windows and to remove excess water during operation.

### SUMMARY

Implementations of a solar panel cleaning system may include an extrusion frame; a driver end coupled to a first side of the extrusion frame; a battery end coupled to a second side of the extrusion frame; a solar panel coupled to a largest planar surface formed by the extrusion frame, the solar panel electrically coupled with a battery included in the battery end, the battery electrically coupled with one or more motors and with a controller included in the driver end; and one or more brushes coupled between the driver end and the battery end, an end of the one or more brushes coupled with the one or more motors. The driver end and the battery end may be configured to couple with one of a track that extends on either side of one or more solar panels or with edges of the one or more solar panels.

Implementations of solar panel cleaning systems may include one, all, or any of the following:

The one or more motors include a first motor and a second motor and the first motor may be coupled to a drive wheel coupled with a drive axle configured to rotate thereby advancing the system along the track.

The second motor may be coupled with the end of the one or more brushes and configured to rotate the brush in a desired rotational direction as the system advances along the track, the brush configured to remove dirt from a surface of the one or more solar panels.

The system may include a sensor system, an infrared light source, and an ultraviolet light source. The sensor system may be configured to detect one or more defects in the one or more solar panels through sensing one of infrared light from the infrared light source, ultraviolet light from the ultraviolet light source, or any combination thereof.

The system may include one or more stop sensors in the driver end coupled with the controller.

The one or more brushes may be made of microfiber brushes.

The system may be configured to be movable to a track coupled with a second one or more solar panels different from the track that extends on either side of the one or more solar panels.

Implementations of a solar panel cleaning system may include a cleaning robot including an extrusion frame; a driver end coupled to a first side of the extrusion frame; a battery end coupled to a second side of the extrusion frame; a solar panel coupled to a largest planar surface formed by the extrusion frame where the solar panel is electrically coupled with a battery included in the battery end. The battery may be electrically coupled with one or more motors and with a cleaning robot controller included in the driver end. The cleaning robot may include one or more brushes coupled between the driver end and the battery end where an end of the one or more brushes coupled with the one or more motors. The system includes a transport robot that may include at least three wheels coupled with a body; a transport and application arm coupled with the body; a transport robot controller included in the body, where the transport robot controller is coupled with a battery coupled with one or more motors coupled with the at least three wheels; and a solar panel coupled with the battery. The driver end and the battery end of the cleaning robot may be configured to removably couple with a track that extends on either side of one or more solar panels. The transport and application arm may be configured to: couple with the cleaning robot to remove the cleaning robot from a track coupled with a first array of solar panels; remain coupled with the cleaning robot while the transport robot moves from a first array of solar panels to a second array of solar panels; couple the cleaning robot with a track coupled with the second array of solar panels; and release the cleaning robot. System.

Implementations of a solar panel cleaning system may include one, all, or any of the following:

The transport robot further may include a global positioning system sensor coupled with the transport robot controller.

The transport robot controller may be configured to use the global positioning system sensor and a global positioning system coordinate of the first array of solar panels and a global positioning system coordinate of the second array of solar panels in moving the transport robot to a position to couple the cleaning robot with the track coupled with the second array of solar panels.

The system may include a sensor array coupled to the body of the transport robot and with the transport robot controller.

The cleaning robot may include a docking structure coupled with one of the extrusion frame, the driver end, or the battery end where the docking structure may be configured to engage with an end of the transport and application arm.

The cleaning robot may include a transceiver coupled with the transport robot controller, the transceiver configured to receive commands via a telecommunication channel from a manual control device.

The cleaning robot may include a transceiver coupled with the transport robot controller, the transceiver configured to receive commands via a telecommunication channel from an automatic control system.

Implementations of a cleaning system may include two guide rails configured to couple on opposing sides of a solar tracking solar panel array; a first retaining frame configured to couple at a first end of the movable solar panel array, the first end oriented perpendicularly with the two guide rails; a second retaining frame configured to couple at a second end of the movable solar panel array, the second end opposing the first end. The system includes a cleaning device housing including a weight, a brush, and at least one roller rotationally coupled with an end of the brush, where the at least one roller is configured to couple with the two guide rails; The cleaning device housing may be configured to slide under only gravity force across a largest planar surface of the movable solar panel array when the solar tracking solar panel array reaches a critical orientation relative to a ground surface each day. The brush may be configured to remove dirt from the largest planar surface as the device housing slides across the largest planar surface. The cleaning device housing may be retained by either the first retaining frame or the second retaining frame by gravity force when not sliding across the largest planar surface of the movable solar panel array.

Implementations of a cleaning system may include one, all, or any of the following:

The system may include wheels coupled at each end of the at least one roller that coupled into the two guide rails.

The system may include no motor.

he weight may be a weighted bar.

The brush may be a microfiber brush.

The system may include three rollers coupled rotationally with the brush via a rubberized gear.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 illustrates a front, isometric view of the window cleaning squeegee system by itself;

FIG. 2 illustrates a rear view of the window cleaning squeegee system by itself and detailing the track and squeegee, and wherein the motor is depicted in hidden lines;

FIG. 3 illustrates a cross-sectional view of the window cleaning squeegee system along line 3-3 in FIG. 2, and detailing the motor housing, guide track, and gear that drives the squeegee thereon;

FIG. 3A illustrates a cross-sectional view of the window cleaning squeegee system along line 3A-3A in FIG. 1, and detailing the inter-relation of the frame, the squeegee, the guide track, and the gear;

FIG. 4 illustrates a side view of the squeegee being driven up or down with respect to the glass;

FIG. 5 illustrates a front, isometric view of the window cleaning squeegee system installed upon a pane of glass of a shower enclosure, and depicting the squeegee moving up and down via the arrows thereon;

FIG. 6A illustrates a block diagram of the various components of the window cleaning squeegee system that involve different sensors and a central processing unit; and

FIG. 6B illustrates a block diagram of the window cleaning squeegee system that involves a battery, on/off button, and motor;

FIG. 7 illustrates a squeegee system with a squeegee bar that has central motor and control buttons;

FIG. 8A shows a side end view of the servo, gear, a squeegee pressed against a window and downward pointing arrow;

FIG. 8B shows the same end view as FIG. 8A but with an upward point arrow and the squeegee away from the window;

FIG. 9 shows the front face of an exemplary squeegee bar with four speakers;

FIG. 10 is a schematic showing a typical array of glass-covered solar panels on which the window cleaning system can be placed, either permanently or movably;

FIG. 11 is a schematic with an exploded view of the cleaning robot;

FIG. 12 is a schematic of the driving side end plate;

FIG. 13 is a schematic with an exploded view of the opposite end of the cleaning robot;

FIG. 14 is a schematic of the battery side end plate;

FIG. 15 is a schematic of the top of the cleaning robot in an isometric view;

FIG. 16 is a schematic of the bottom of the cleaning robot in an isometric view;

FIG. 17 is a schematic showing a simplified view of the extrusion frame;

FIG. 18 is a schematic of a cross section of the extrusion frame;

FIG. 19 is a schematic cross section including the attachment of the longitudinal bars and cross pieces;

FIG. 20 is a schematic illustrating the attachment of the extrusion frame to the inner plate of the driving end;

FIG. 21 is a perspective view of a cleaning robot implementation attached to a frame attached to two solar panel arrays;

FIG. 22 is a perspective view of a cleaning robot implementation coupled to an end of a frame attached to two solar panel arrays;

FIG. 23 is a perspective view of an implementation of a cleaning robot coupled to a solar tracking solar panel array;

FIG. 24 is an interior view of components of the cleaning robot of FIG. 23;

FIG. 25 is a perspective view of an implementation of a transport robot;

FIG. 26 is a perspective view of a frame coupled with a solar tracking solar panel array with a cleaning robot thereon;

FIG. 27 is a bottom view of a cleaning robot adjacent a support frame coupled with a plurality of solar panel arrays;

FIG. 28 is a perspective see-through view of components of the cleaning robot coupled with a plurality of solar panel arrays showing a frame implementation;

FIG. 29 is a perspective view of an end of a cleaning robot with cover panels removed;

FIG. 30 is a perspective view of another implementation of a cleaning robot with a cover; and

FIG. 31 is a perspective of the cleaning robot of FIG. 30 with the cover removed.

### DESCRIPTION

This disclosure, its aspects and implementations, are not limited to the specific components, assembly procedures or method elements disclosed herein. Many additional components, assembly procedures and/or method elements known in the art consistent with the intended cleaning systems will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such cleaning systems, and implementing components and methods, consistent with the intended operation and methods.

Various cleaning systems disclosed herein may keep windows bright and solar panels clean and more effective than if dust or sand were to accumulate thereon.

In various system implementations, the system includes two sidetracks in which an arm holds a squeegee against the glass on the downward stroke. Preferably the squeegee is positioned away from the glass on the upward stroke. The squeegee arm may incorporate other elements, such as a glass cleaner container, motor, sound system with speakers, light, camera, motion and rain sensors, and a computer to operate the window washing system and its components.

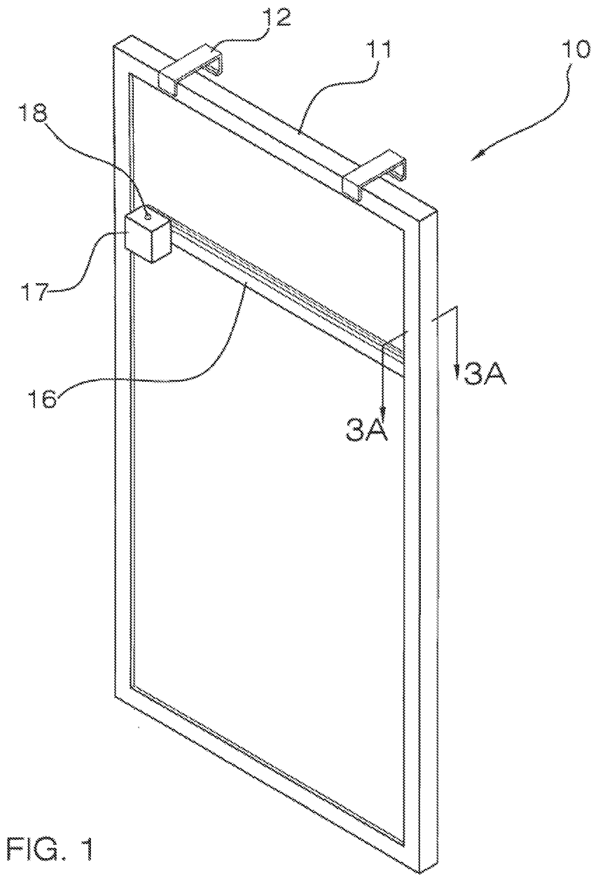

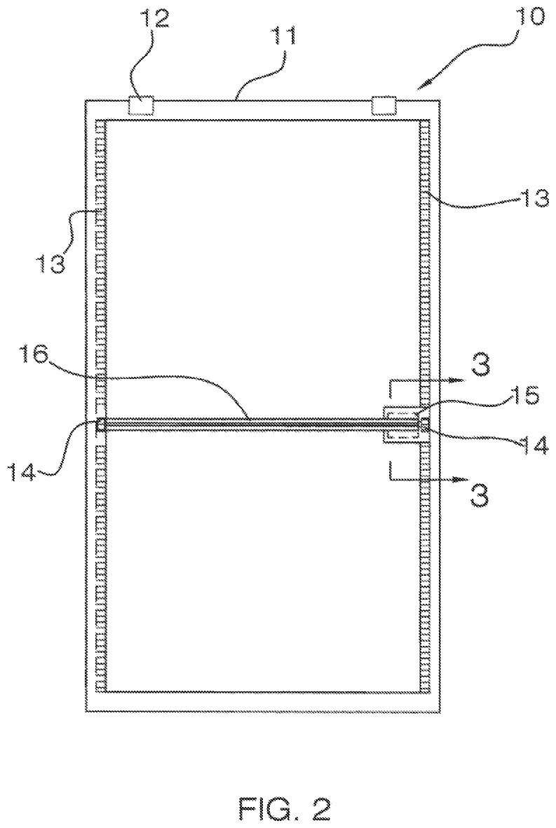

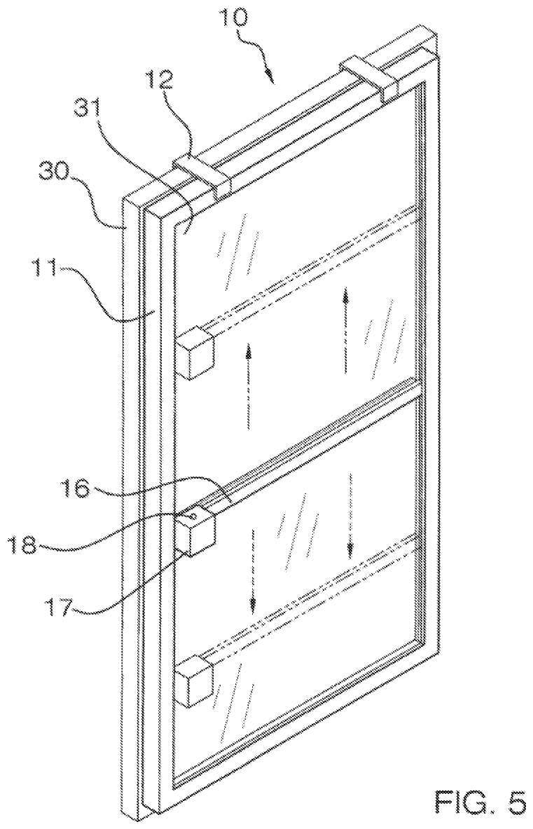

Detailed reference will now be made to a particular implementation, examples of which are illustrated in FIGS. 1-5. An glass cleaning squeegee system 10 has been designed for use with showers. It includes a frame 11, at least one bracket 12, a guide track 13, a gear 14, a motor 15, a squeegee 16, and a housing 17. The frame 11 rests adjacent a glass pane 31 of a shower glass enclosure 30. The frame 11 is positioned adjacent the glass pane 31 via the bracket(s) 12, which clips onto the shower glass enclosure 30. The frame 11 consists of a plurality of pieces that form an outline that mirrors the overall shape of the glass pane 31. The frame 11 and the bracket(s) 12 are made of a material comprising a wood, plastic, metal, or carbon fiber. The bracket(s) 12 attach along a top piece of the frame 11. The bracket is attached to the frame by any fastening means including but not limited to adhesive, bolts, nails, screws, rivets, welding the two parts together, casting the two parts together, or molding the two parts together. For the shower and other cleaning systems, a bracket need not be used. Alternatives to the bracket include but are not limited to adhesive, bolts, nails, screws and rivets.

Located upon a left side and a right side of the pieces of the frame 11 are guide tracks 13. The guide tracks 13 enable the invention 10 to squeegee the entire surface of the glass pane 31 by enabling the squeegee 16 to traverse the entire length of the glass pane 31 vertically. Paired guide tracks are required, but not the horizontal pieces of the frame. If the horizontal pieces of the frame 11 are eliminated, the guide tracks 13 must be firmly attached to the glass pane 31 or other nonporous surface. Firm attachments include but are not limited to adhesive, bolts, nails, screws and rivets.

The gear 14 has gear teeth that correspond with the guide track 13 to enable the gear 14, the motor 15, and the squeegee 16 to traverse up and down the guide track 13, and in essence squeegee the entire surface of the glass pane 31, namely the surface within the frame 11. By moving the frame 11, one cleans another area.

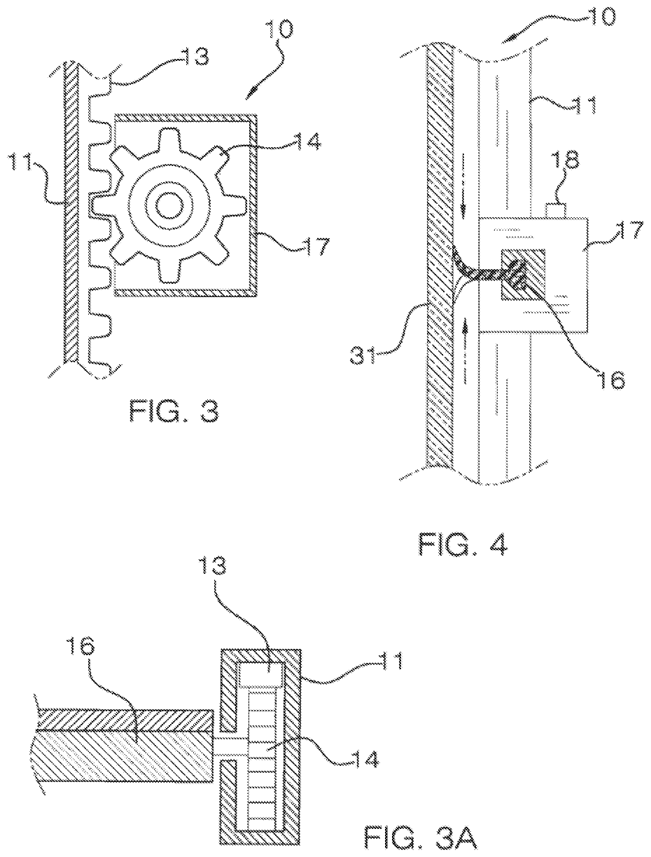

In FIG. 3A, the cross-sectional view illustrates the interrelation of the gear 14, the guide track 14, the frame 11, and the squeegee 16 on the non-motored side of the invention 10. The frame 11 essentially encompasses the gear 14 and track 13 thereby enabling proper alignment and maintaining a horizontal orientation of the squeegee 16 across the frame 11 and the glass frame 31. The squeegee 16 is of a traditional form, and is made of a rubber or material that is suitable for wiping water off a ceramic or smooth surface. The squeegee 16 has an overall length that is less than or equal to the overall width of the glass pane 31. The squeegee 16 fits within the frame 11, and squeegee bar is capable of vertical movement, either up or down, within the frame 11 (FIG. 4). In other embodiments, the squeegee can be interchanged with other cleaning tools, such as brushes held stationary or spun at the bar moves up and down the window. Other tools can also be interchangeably installed in the same position as the squeegee.

The system 10 may include an on/off button 18 to operate the motor 15. However, it shall be noted that a motion sensor 18A and a central processing unit 18B (hereinafter CPU) may be included to provide automatic operation of the invention 10 by turning the invention 10 on or off by itself when a person has been detected for a predetermined amount of time, and after said person has left detection for a predetermined amount of time. However, it shall be noted that a rain sensor 18C may be included to provided automatic operation of the system 10 by turning the system 10 on or off by itself when water is detected upon either the housing 17 or the glass pane 31.

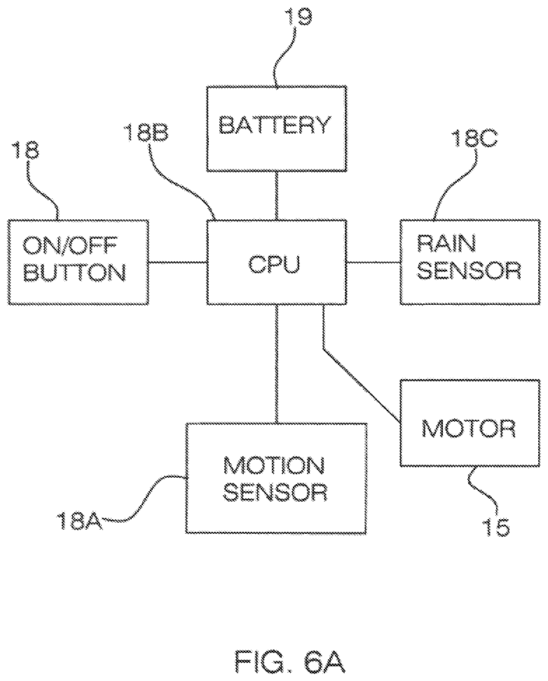

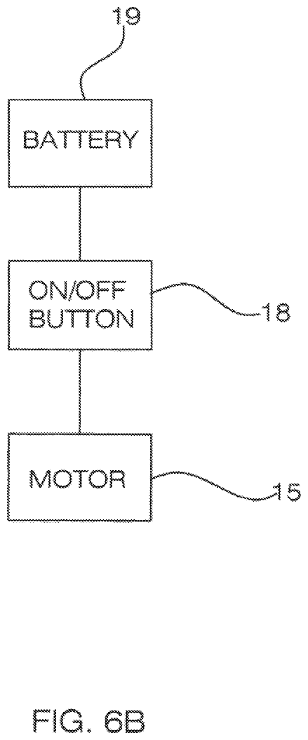

The system 10 is powered by at least one battery 19, which is connected by wire to the CPU 18B or to the on/off button 18. The battery 19 may be referred to as a powering means, and may involve a plurality of batteries. Referring to FIGS. 6A and 6B, the system 10 may include the CPU 18B and the on/off button 18, the motion sensor 18A or the rain sensor 18C; or simply the on/off button 18. The battery 19 provides power to the motor 15. In FIG. 6A, the battery 19 is wired to the CPU 18B, which in turn is wired to the motor 15. In FIG. 6B, the battery 19 is connected to the on/off button, which is connected to the motor 15.

The housing 17 partially contains the gear 14 and the motor 15, and forms a waterproofed enclosure to protect both the gear 14 and the motor 15 from water associated with use of a shower. The housing is made of a material comprising a plastic, metal, wood, or carbon fiber composite.

### Example 1

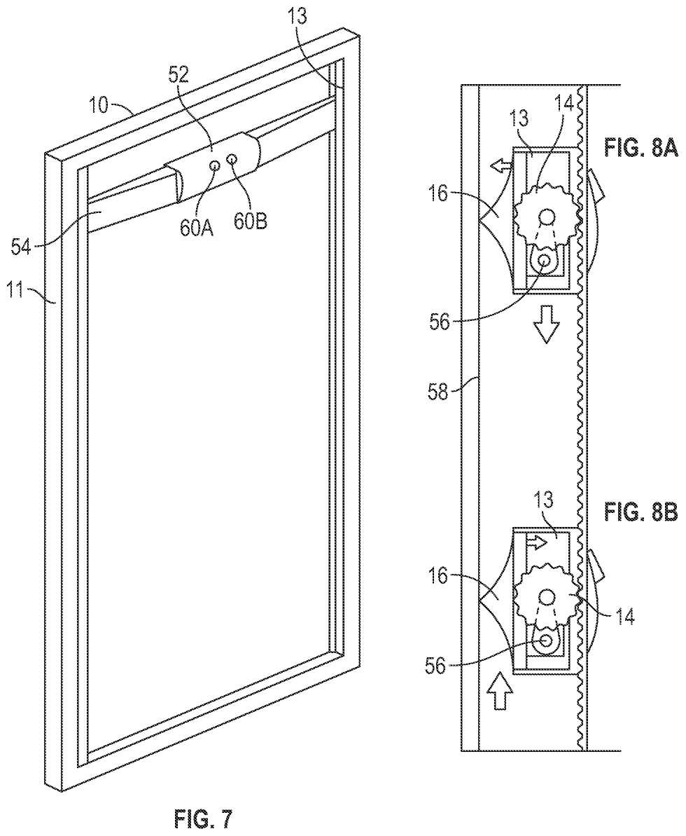

FIGS. 7, 8A, and 8B show an implementation of a window washing system 10 that has a control panel 52 and motor (not shown) in the center of the squeegee bar 54. As illustrated, this system 10 has a frame 11, guide tracks 13 with indentations for gear teeth. This version has a central motor with attached rods that drives the gears. FIG. 8 displays side views of the end of the squeegee bar with the servo 56, gear 14, guide track 13 with teeth and squeegee 16. FIG. 8A shows the system in action with the squeegee tip 16 pressed against the glass surface 58 and moving downward. FIG. 8B shows the system returning to its default position, without the squeegee 16 touching the glass surface 58 and thus not depositing water back onto the glass 58. Although one servo 56 is shown, more than one servo can be used to change the direction of the squeegee bar 54 movement (up or down) and/or to move the squeegee toward or away from the glass.

FIG. 7 shows an implementation with a plurality of control buttons, for example, a pair 60A and 60B in the center of the squeegee bar 54. One button 60A or 60B permits the user to control squeegee movement by turning it on or off. In one implementation, one touch of a control button 60A or 60B activates a program that causes the squeegee bar 54 to move from the top to the bottom of the frame and back up to its default position at the top of the frame. Alternatively, one of the buttons 60A or 60B can be replaced with a water sensor that automatically activates the squeegee motor, preferably on a timer that activates the squeegee motor after the shower is completed.

This window washer design with an enlarged squeegee bar 54 lends itself to other useful shower functions that currently are only available separately. For example, a sound source and light are now installed separately and can interfere with the appearance of the shower area. Optionally a sound source or entertainment system could be installed, including, but not limited to a music player or radio. One of the control buttons 60A or 60B can be connected to the battery to send power to the sound source. Another control button(s) selects the sound and adjust the volume. Optionally a slot (not shown) in the top of the squeegee bar 54 accommodates an entertainment source including but not limited to an MP3 player or iPOD® player or a BLUETOOTH® receiver.

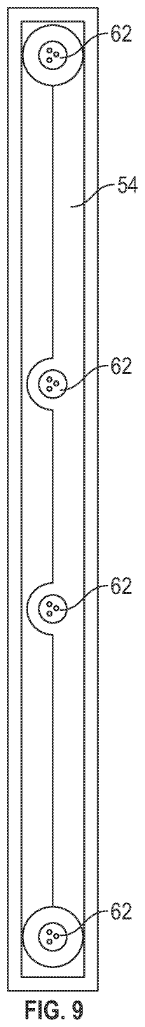

FIG. 9 is a schematic showing an implementation with four speakers 62 (preferably waterproof) installed on a surface of the squeegee bar 54. The sound system requires at least one speaker, and the speaker(s) can be installed on any surface of the bar. Alternately, wireless speakers can be installed in other shower locations, when the sound system has the capacity to send wireless signals, including but not limited to BLUETOOTH® technology.

Oftentimes, it is difficult to see in the shower, which frequently is equipped with only one low-wattage lamp. This is particularly problematic for older people. To assist with illumination a light bar (not shown) is may be included within the design of the squeegee bar 54. The light bar may be installed on the lower surface of the squeegee bar 54 to shed light downward into the shower. The light is controlled by a button on the central control panel. Alternately, the light can be activated immediately via motion or water sensor and turned off by the timer activating the motor.

### Example 2

Another implementation involves monitoring solar panels, also called photovoltaic cells. Solar panel productivity decreases over time. First, solar panels get dust on them that may be sealed in place with infrequent light rain, followed by more dust, as is seen in desert climates. This decreases the amount of sunlight reaching the solar panels and the electricity produced thereby. Second, cracks may appear that are due to hail or quick temperature changes; water may then seep in and diminish productivity. Third, shorts in the electronics of the solar panel can cause discoloration of the overlying glass and decrease function.

FIGS. 11-20 show an implementation of a cleaning/analysis robot (“cleaning robot”). This implementation is a rolling solar panel cleaner that is equipped with its own solar panels that provide energy to the motors, at least one motor used to roll the cleaning robot sideways and at least another motor used to move the cleaning brush(es). The cleaning robot moves sideways along a continuous array of solar panels/cells. In various implementations, a support track may be included along a side of the solar panel array on which the cleaning robot runs. In other implementations, the cleaning robot may move along the edges of the solar panel array itself. In various implementations, attached to the underside (e.g., brush assembly) are light sources with two different wavelengths, infrared and ultraviolet, that are useful for detecting cracks and discoloration. These lights and corresponding detecting sensors/cameras may be used as the cleaning robot moves across the solar panel array at night to perform defect detection while minimizing ambient light interference.

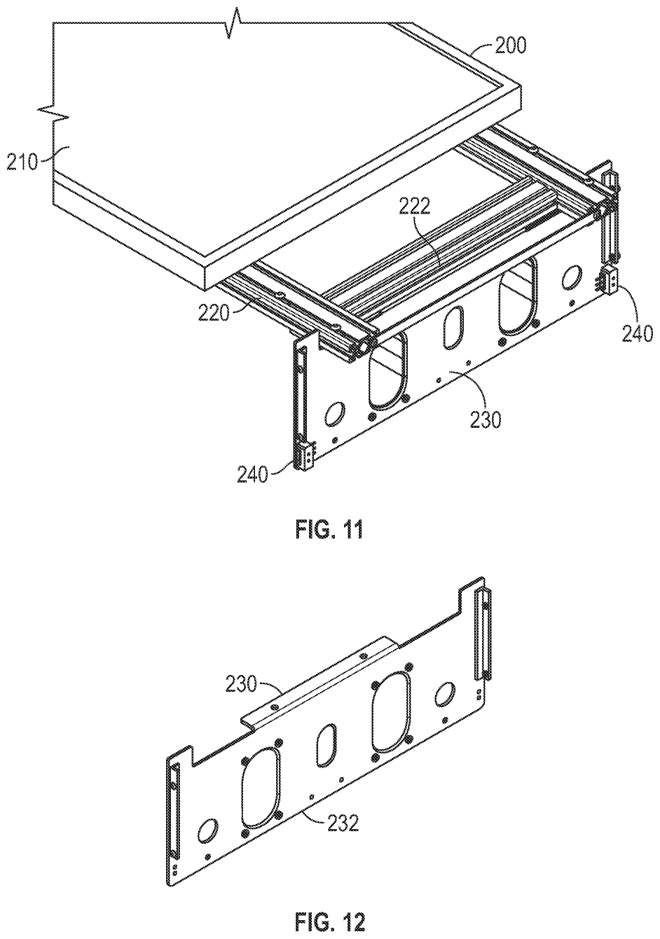

FIG. 11 shows an end view of a driver end of a cleaning robot implementation 200 with cover pieces and motor components removed. Starting at the top is a solar panel base 201 that sits atop a set of rails 220 and cross pieces 222 (extrusion frame) that connects the two ends of the cleaning robot 200. The driver end 230 encapsulates the motors for the lateral movement and brush movement (not shown). Driver end 230 also has two stop sensors 240 to control the lateral movement in combination with a controller (not shown in FIG. 11). FIG. 12 shows more detail of the driver end 230, namely the inner plate 232. Two large ovals are designed to accommodate two motors (not shown).

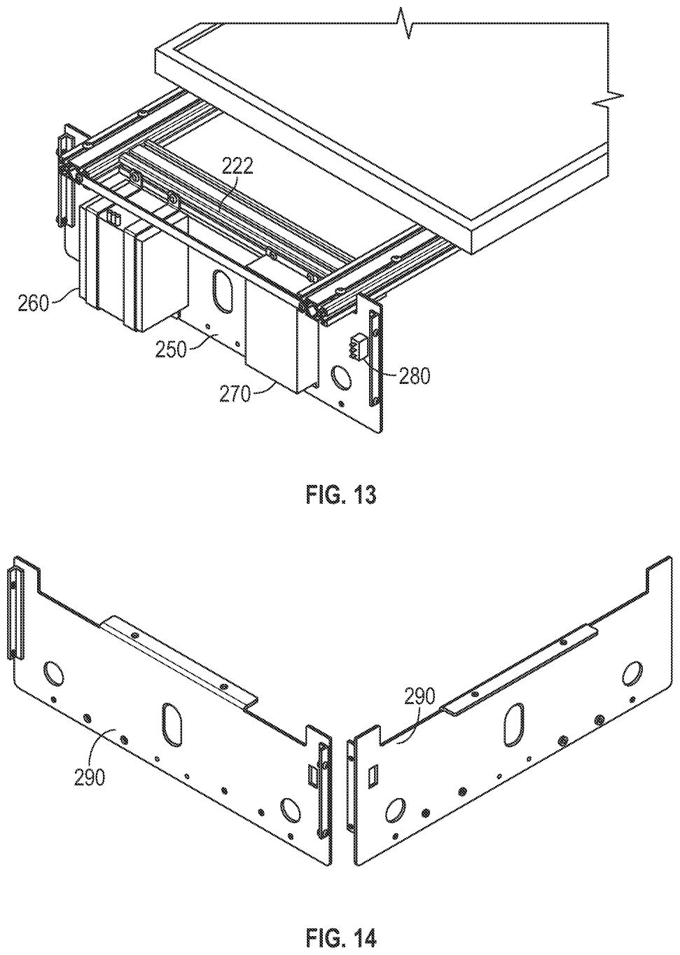

FIG. 13 shows an end view of the opposite end, or battery end 250 with cover pieces removed. The battery 260 is shown attached by screws to the cross pieces 222. A controller 270 is also attached to the inner plate 250. On the battery side 250 is also an on-off switch 280. The battery 260 and controller 270 are electrically connected with each other and with the solar panel 210. FIG. 14 shows two views of the inner plate 250 of the battery end 250.

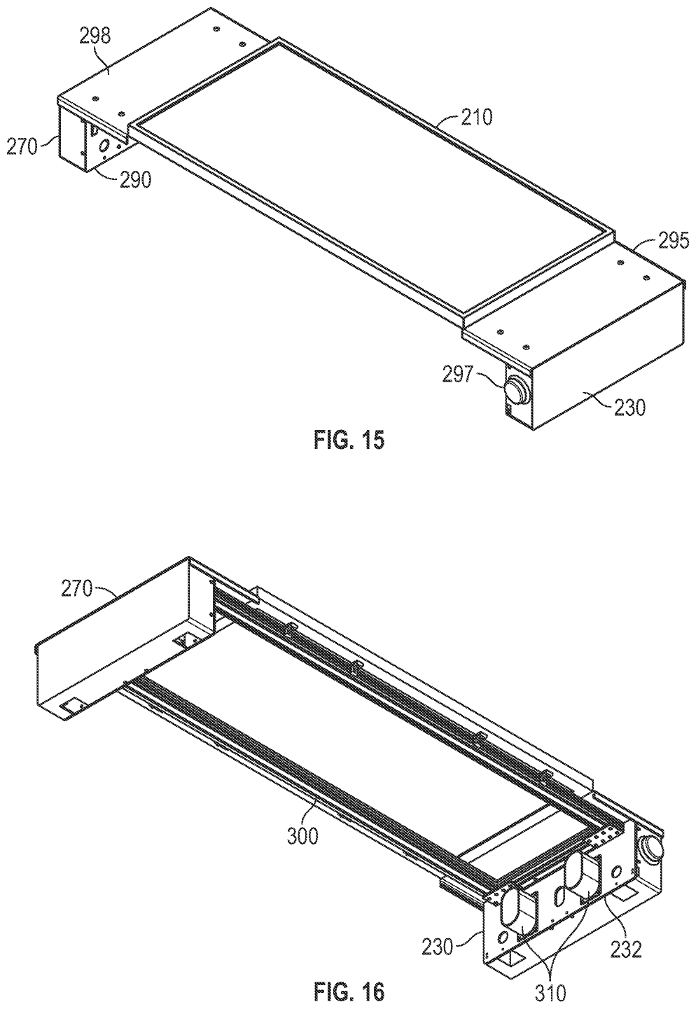

FIG. 15 is a top, isometric view of the new cleaning robot 200 that has all areas enclosed with covers. The solar panel base 201 is at the top. At the left-hand end is the battery end 270, whose inner plate 290 and cover over the battery 298 are visible. At the right-hand end is the driver end 230, shown with a top cover 295 and an alternative implementation of a on-off switch 297 on the side.

FIG. 16 is a bottom, isometric view of FIG. 15. Under the solar panel base 201 shown above is an extrusion frame 300. Also shown is the battery side 270 enclosed in a cover. On the driver side 230 is shown the inner plate 232 of the driver side. Two motor covers 310 project from the inner plate 232. In this view, the drive wheels and the cleaning brush are omitted, but the drive wheels or cleaning brush may be any similar structure disclosed in this document in particular implementations.

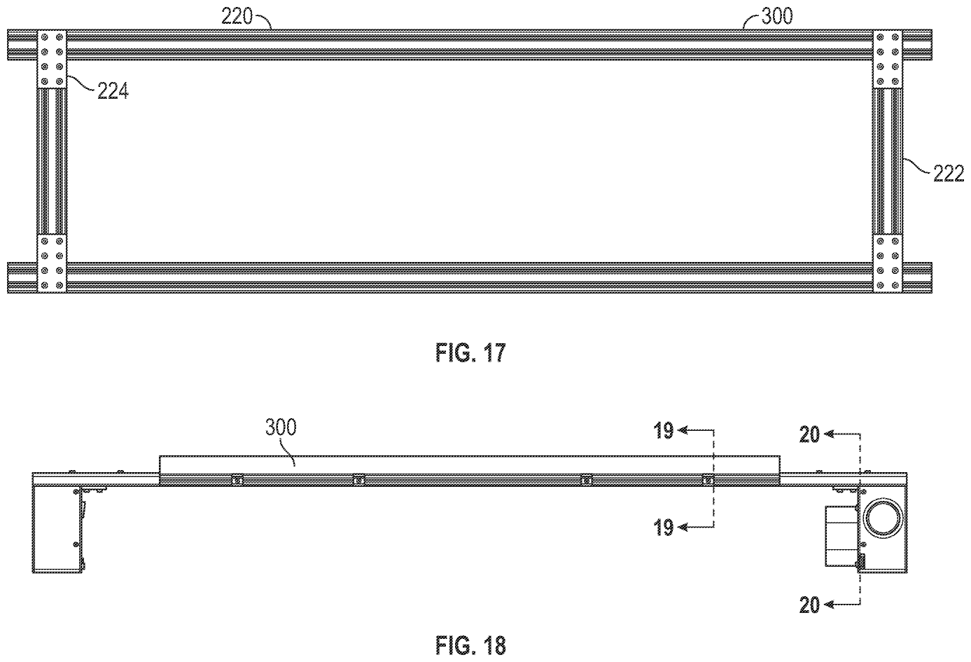

FIG. 17 shows a detail view of the extrusion frame 300 of FIG. 16. Note that the longitudinal bars 220 extend beyond the crosspieces 222. At least part of those extensions support the battery and driver ends (not shown in this figure). In various implementations, the corners of the bars 220 and crosspieces 222 are secured with eight-hole brackets 224.

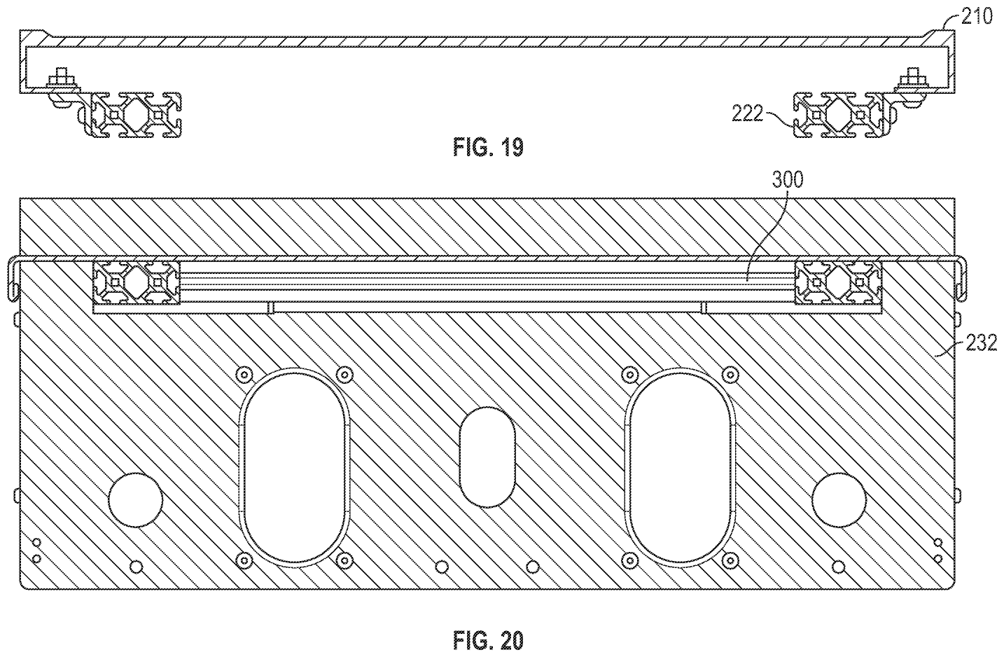

FIG. 18 shows a front end view of the extrusion frame 300 of FIG. 15 showing sectional lines 19 and 20. Cross sections at each of sectional lines 19 and 20 are illustrated in FIGS. 19 and 20, respectively.

FIG. 19 shows attachment of the solar panel 210 to the crosspieces 222, while FIG. 20 shows the attachment of the extrusion frame 300 to the inner plate 232 of the motor end. While not shown, the extrusion frame 300 can be similarly attached to the inner plate 290 of the battery end.

### Example 3

An implementation of a cleaning robot like that illustrated in FIGS. 11-20 was tested by a university laboratory on four solar modules composed of poly-crystalline cells to see how well the system would remove deposited dirt. An indoor deposition chamber was used that had four Peltier elements to create a thermoelectric effect. The Peltier elements provided cooling in forward bias mode and heating in reverse bias mode. A cool-mist humidifier was also used to bring the chamber to the desired relative humidity.

A compressed nitrogen tank was used to provide air bursts to disperse soil into the air to form a dust cloud. An LED light source irradiating the four solar modules was used to provide uniform light to enable uniform readings of electricity between each soil deposition cycle.

For these experiments a test rack with a track for engagement with the cleaning robot's drive wheels was modified to accommodate one row of solar panels. Thus, the soiled test solar panels were placed between full sized solar panels so the robot could perform under normal operations, passing over all solar panels equally.

In various implementations, the controller of the cleaning robot may include networking components, such as a Wi-Fi network. Users may be able to access the controller using the Wi-Fi network to access a control program software program on the controller.

The following performance parameters were utilized and measured for each soil deposition cycle during the testing: First, control isc measurements were taken of the clean panels under the LED light and recorded. Next, the panels were cooled to 11° C. for 10 min to simulate dew. Humidity was then injected into the chamber to achieve the set-point of 40% humidity. Soil was dispersed with nitrogen gas at 40 psi using 2 g of premeasured soil. A settling time was allowed for the dust cloud to clear and settle on the solar panels. The panels were then baked at 70° C. for 10 min. The isc measurements were then recorded and any performance loss calculated.

For the first test, the above process was repeated until all the test modules lost between 15 and 18% of their ability to provided current (measured in amps). The soiled modules were then installed on the test rack and the cleaning robot was programmed to make one round trip over the modules. After the single cleaning cycle, the isc measurements were then taken and compared with initial values.

For the second test, following the same cycle sequence as above, the humidity was increased to 70% and each module received a different number of repeated soil deposition cycles: 1, 2, 3 and 4. Once initial soil and measurements were completed, the modules were again installed on the test rack and subject to only a single pass with the robot (no return trip). The test modules were removed, and final isc measurements were taken.

The data from the above tests indicate that the cleaning robot returned isc values to about 93.7% to 100%. Taking into account error caused by fluctuation seen in the ammeter, the effectiveness of the cleaning provided by the robot approached 100% for all panels. Regardless of humidity and number of soil layers, the cleaning robot was able to clean the soiled test modules pack to within 6.25% of their starting isc values. Taking into account the ammeter fluctuation, the cleaning robot was able to clean the panels close to their starting values.

Another implementation of a cleaning robot is included in a home and commercial window washing system that shows a variation of the squeegee bar previously discussed. This implementation has a larger squeegee bar, or housing to accommodate window washing fluid container. This implementation can be retrofitted on buildings, or it can be installed as the windows are being installed, in which case, electricity can be optionally hardwired to the unit. In particular implementations, the cleaning robot may have three speakers although any number can be used. Alternatively, one or more of the speaker positions is occupied with devices including but not limited to a camera and/or light.

The in various implementations, the cleaning robot containing window washing fluid container may be heavy enough to drag the squeegee bar down and may not require much if any energy expenditure on its downward path. This may be be highly advantageous for energy saving to use on moving the squeegee bar back to its default position at the top of the frame. For commercial use, the front of the window washing system bar can carry the company logo or name, a glowing front for light effects, and/or advertisement for the building or other company, among other decors. For high rises, particularly where electricity is not immediately available on the building skin, the window washing bar can be covered on sun-exposed surfaces with solar panels to help recharge the contained batteries in the cleaning robot. Alternatively, rechargeable batteries can be recharged when not in use by returning the window washing bar to the top of the frame and connecting an outlet (not shown) on the window washing bar to any power source.

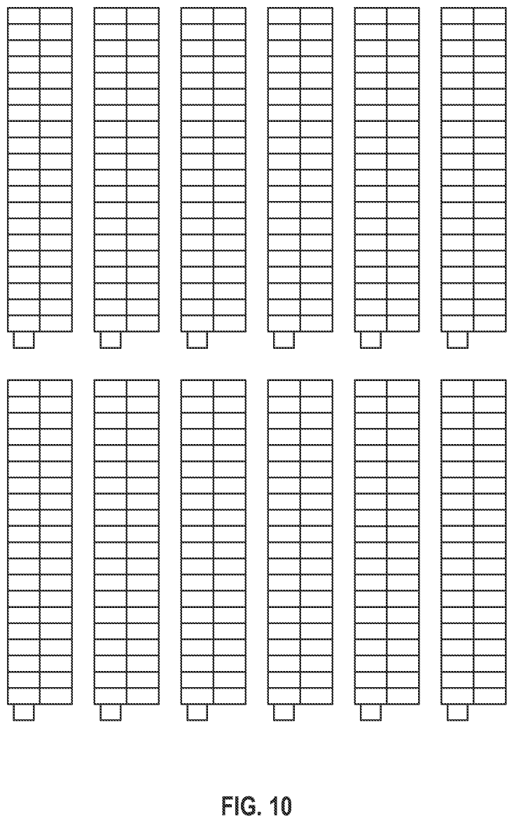

For outdoor, cold weather conditions, a heating element and a scraper can be installed in the system bar to remove ice and snow. The heating element keeps the washing fluid warm and liquid for dispensing. This commercial window washing system may be particularly useful for very high rises, subject to wind gusts and dangers to workers. Where the cleaning robot is fully automated, it can discretely cleans windows without invading the privacy of condominium owners or office workers. This system can be manufactured into or retrofitted on buildings with glass and/or windows, including but not limited to homes, office buildings, solar collecting panels (see FIG. 10), aquariums, underwater applications, and glass walls.

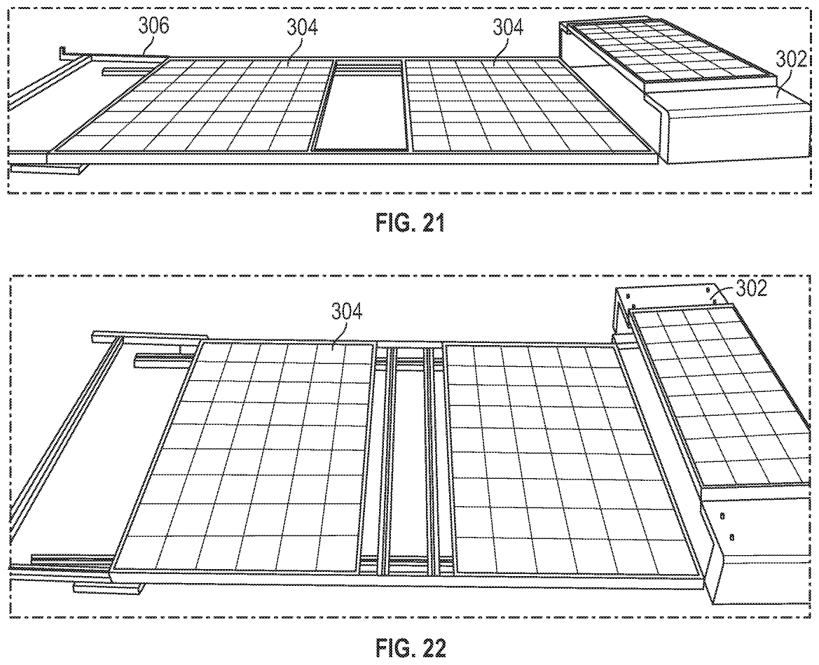

Referring to FIG. 21, an implementation of a cleaning robot 302 is illustrated coupled to a frame coupled with an array of solar panels 304. Example of the structure of the frame 306 to which the cleaning were about 302 is coupled can be seen at the left side of FIG. 21. FIG. 22 is another perspective view of the cleaning robot 302 and its position relative to the solar panels 304. As illustrated, the cleaning robot contains an interior space which includes a cleaning brush therein driven by a motor which spins as the cleaning robot move side to side a cross the solar panel array 304. This space is designed to allow the brush to operate as the robot passes over the largest planar surface of the solar panel array 34.

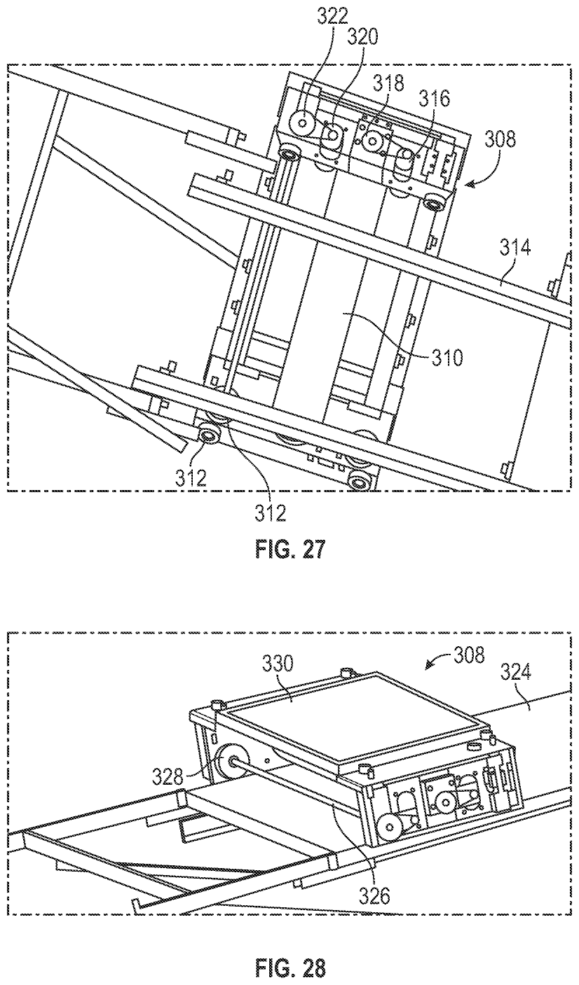

Referring to FIG. 27, a bottom see-through view of an implementation of a cleaning robot 308 is illustrated. As illustrated, the robot includes a brush 310 and a set of perpendicularly oriented/aligned pairs of wheels 312 which are designed to contact both a side of the solar panel array or track and a top surface of the same. An implementation of a frame configured to couple with the pairs of wheels 312 is illustrated in FIG. 27. As illustrated, one of the motors 316 is coupled via a belt to a drive mechanism 318 that drives the brush 310. A second motor 320 is also coupled using a belt to a drive mechanism 322 which is used to drive one of the two pairs of wheels 312. While the use of a motor to drive only one set of the pairs of wheels is illustrated in FIG. 27, more than one set of the wheels may be powered using more than one drive motor or by the same drive motor. Also, more than one brush driven by more than one motor or the same motor may be employed in various implementations.

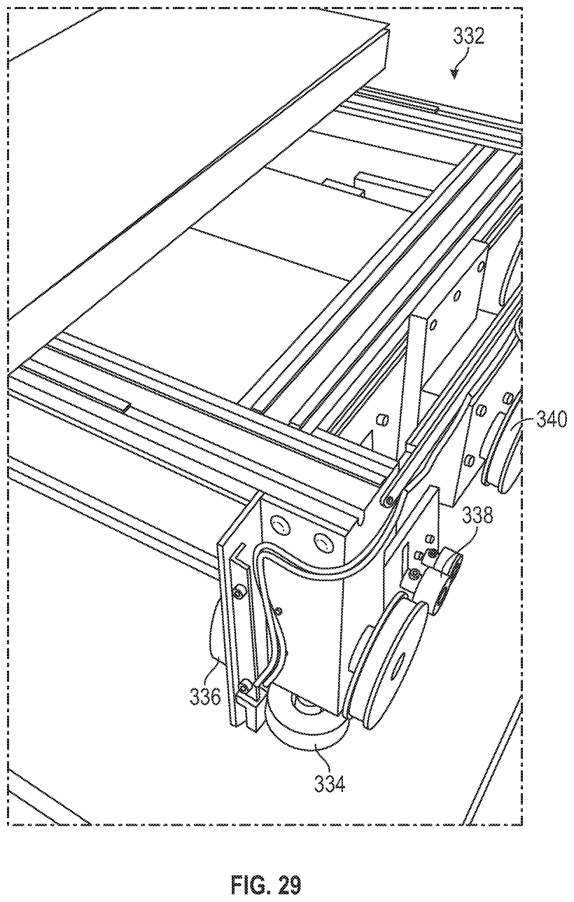

FIG. 28 illustrates the cleaning robot implementation 308 of FIG. 24 at a perspective view with the robot resting above a solar panel 324. Here the axle 326 that couples opposing corresponding drive wheels 328 is illustrated. The other drive wheel of each pair is not visible in this view but is oriented substantially perpendicularly resting against the side of the solar panel 324. Like other cleaning robot implementations disclosed herein, the cleaning robot 308 includes a solar panel 330 and a corresponding battery and controller coupled electrically with the motors that drive the robot and the brush.

FIG. 29 illustrates an implementation of the cleaning robot 332 with covers removed that shows a pair of drive wheels 334 and 336. As illustrated drive wheel 336 is configured to rest on an edge of the largest planar surface of a solar panel while perpendicularly aligned drive wheel 334 is designed to rest against a thickness or side of the solar panel. In this way the robot can be held securely in place on each side of the solar panel as it traverses across the largest planar surface of the solar panel. In this implementation instead of the use of belts to connect the motor with the drive wheel the use of an intermediate wheel 338 is used to transfer power from the motor shaft to the drive wheels. A corresponding power transfer wheel 340 for the motor driving the brush is illustrated which is coupled with the brush inside the robot 332.

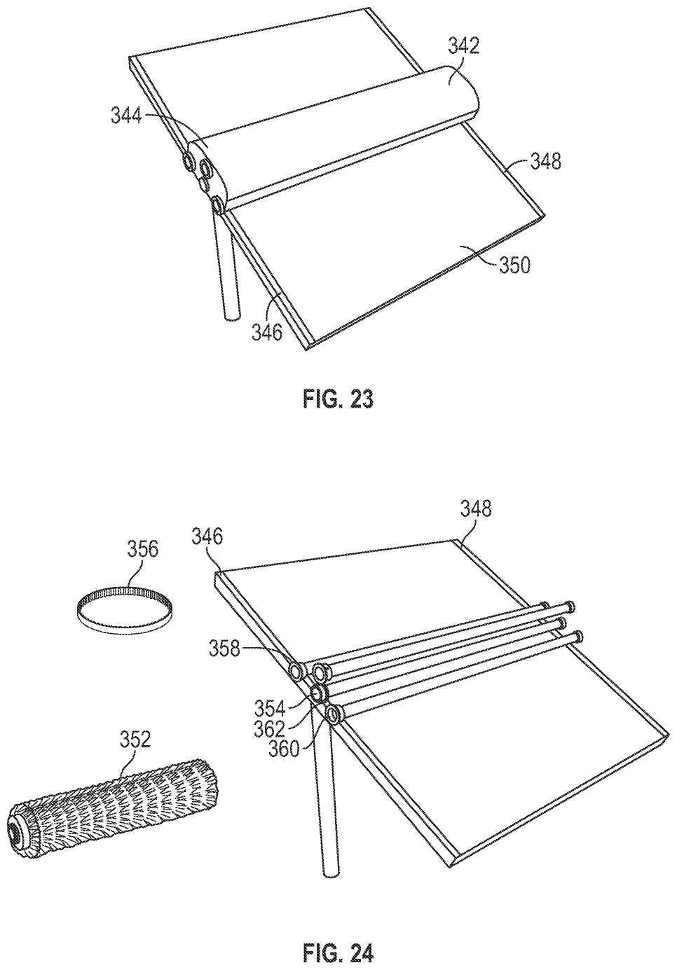

While the various cleaning robot implementations illustrated herein have utilized motors to power the robot's movement across the largest planar surface of a nonporous surface for cleaning, in other implementations only gravity force may be used. This may be particularly useful in situations where the solar panel itself moves regularly throughout the day as when the solar panel is a solar tracking solar panel system that contains its own motor used to track the movement of the sign from the morning until sunset. Since the angle of a solar tracking solar panel system regularly shifts, a cleaning robot can be designed that is configured to slide across the surface of the solar tracking solar panel when the angle of the panel reaches a certain critical angle relative to the ground or panel support. An implementations of such a cleaning system 342 is illustrated in FIG. 23. As illustrated, the system includes a housing 344 and a set of wheels/bearings designed to engage in to guide rails 346, 348 that are coupled to each side of a solar tracking solar panel array 350. In FIG. 23, the cleaning system is illustrated in the middle of a traverse using only gravity force from a top end of the solar panel 350 to a bottom in of the solar panel 350. FIG. 24 illustrates a see-through view of the housing illustrating various components used to enable the cleaning system 342 to spin a brush 352 coupled to a shaft 354 which is driven using a belt 356 coupled around one or more axles 358, 360 engaging with a rubberized gear 362 attached to the shaft 354. As the system slides under gravity force along the guides 346, 348 the axles 358 under the influence of a weight in the system (which may be a weighted bar in various implementations), a correspondingly driven rotation of the brush 352 via the belt 356 may take place. In this way, the solar tracking solar panel system receives two cleanings per day each day as the cleaning system alternates from one end of the system to another, changing places using only gravity force. Because only the gravity force is needed, no motors or other control systems or batteries may be needed to drive the system.

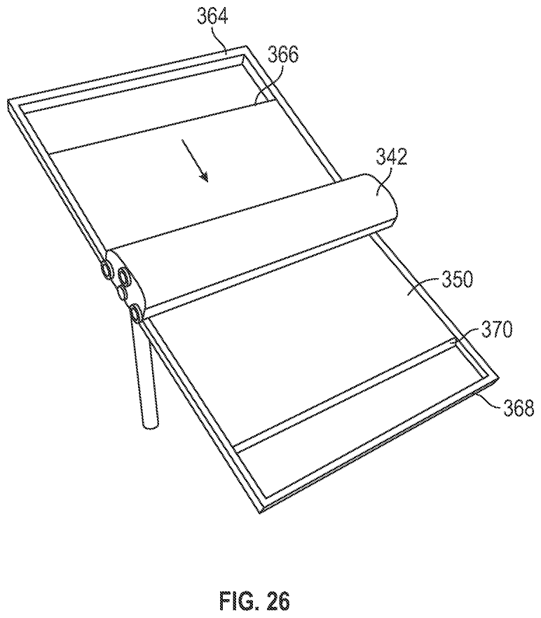

Referring to FIG. 26, an implementation of the cleaning system 342 is illustrated while traversing from a first retaining frame 364 coupled at a first and 366 of the solar panel array 352 a second retaining frame 368 coupled at a second and a 370 of the panel. As illustrated, the first retaining frame 364 and second retaining frame 368 are sized to allow the robot to rest just off the surface of the panel in such a way as to not shade the panel during its normal operation.

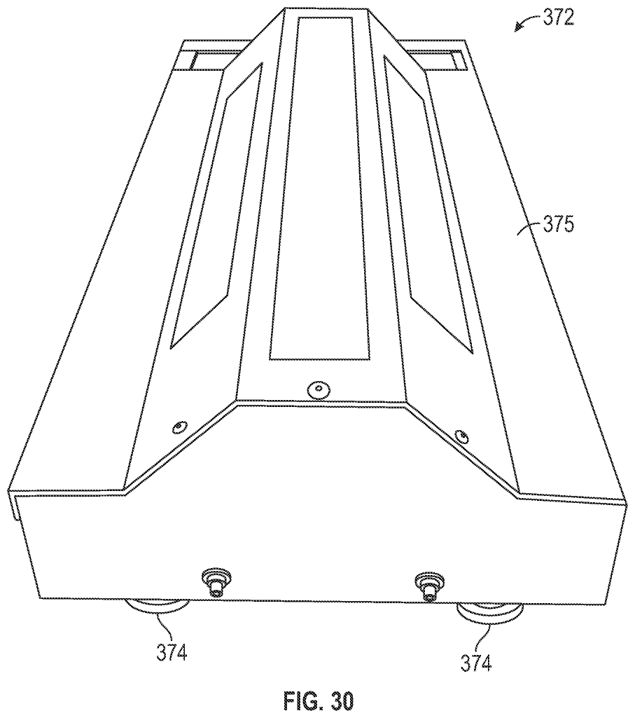

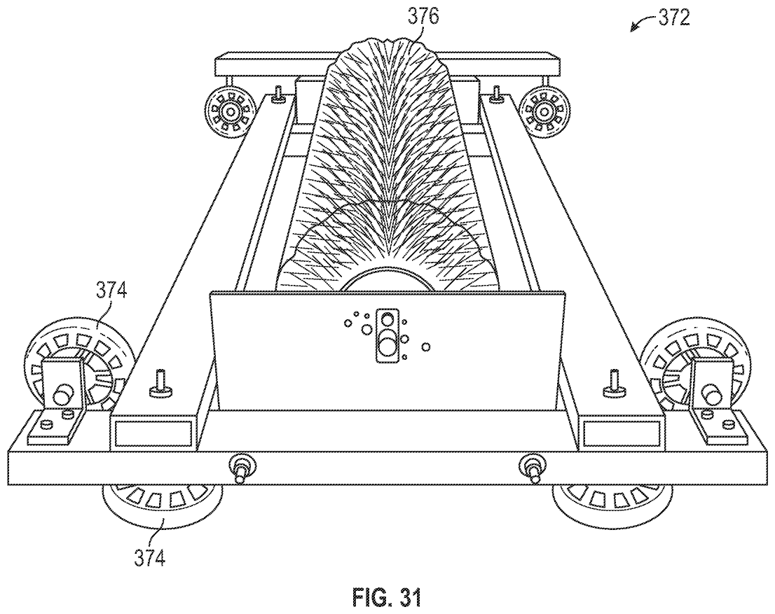

Referring to FIG. 30, other gravity driven cleaning systems may be devised for a wide variety of applications other than solar panel arrays. In the implementation of a cleaning system 372 illustrated FIG. 30, the system is designed to slide along a guide real while driving a brush. The drive wheels 374 are visible extending from a housing 375 covering the internal components of the system. Referring to FIG. 31, the cleaning system 372 is illustrated with the housing removed showing that drive wheels 374 arranged in perpendicularly arranged pairs similar to the other implementations disclosed herein. A power transfer mechanism that allows movement from one or more of the pairs of wheels to drive a spinning motion of the brush 376 may be included in various implementations. However, in other implementations, the brush 376 may not be powered and may simply be free to rotate while cleaning as the cleaning system 372 passes over a cleaning surface under gravity force. Various implementations of brushes disclosed herein may be micro fiber brushes in various implementations.

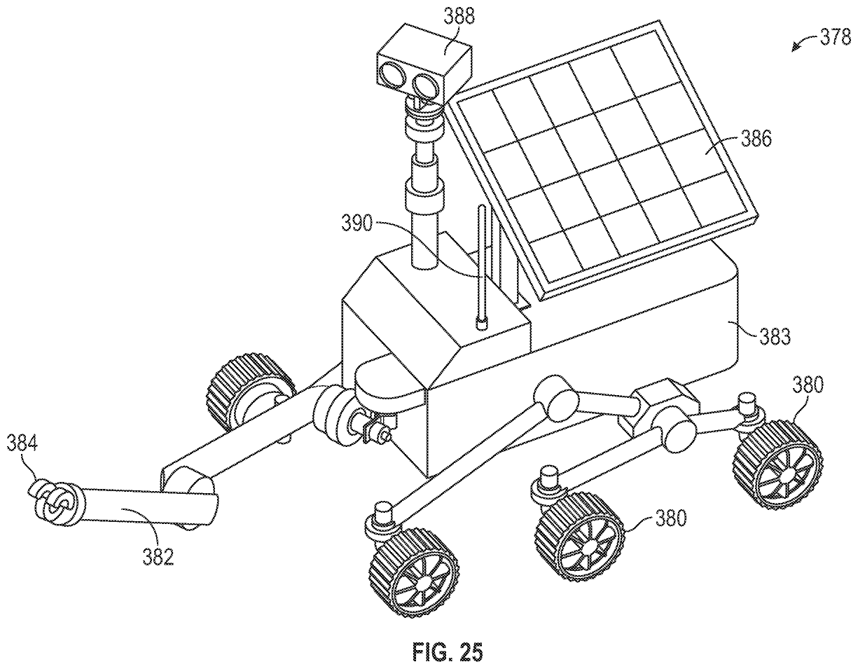

In various cleaning system implementations, the cleaning robots may need to be transferred between along rows or arrays of solar panels for example, in a commercial solar farm. In order to reduce the expense of having a dedicated cleaning robot for each row of panels in the farm, a transport robot may be utilized to carry one or more cleaning robots from row to row according to a desired cleaning schedule. Referring to FIG. 25, an implementation of a transport robot 378 is illustrated. As illustrated, the robot includes wheels 380. While in the implementation illustrated in FIG. 25, six wheels are used, as few as three wheels may be employed in various implementations where a tricycle suspension system is utilized. The transport robot 378 includes a transport and application arm 382 coupled to a body 383 of the robot which is designed to couple with a cleaning robot, remove it from its location on a solar panel array and then hold the cleaning robot in place as the transport robot moves to the next row. The transport and application arm 382 then is used to couple the cleaning robot with the new ray of solar panels. Various designs for the end of 384 of the arm 382 may be devised depending upon the particular structure of a docking structure coupled with the particular cleaning robot being transported. The cleaning robots that may be used in conjunction with the transport robot 378 may be any disclosed in this document but particularly those motorized designs that employ brushes with extrusion frames, driver ends, and battery ends. The docking structure of the cleaning robot may be coupled to any portion of the cleaning robot including, by non-limiting example, the extrusion frame, the driver and, or the battery end.

In various implementations, the body 383 may include a battery and a transport robot controller electrically coupled with the wheels, drive motors, and the transport application arm 384. The battery may receive power from solar panel 386 in various implementations. In various implementations, a global positioning system sensor is coupled with the controller in the body 383. In various implementations, as illustrated in FIG. 25, a sensor array 388 may also be included, which may contain any of a wide variety of sensor such as, by non-limiting example, cameras, infrared sensors, ultraviolet sensors, gyroscopic sensors, rotational sensors, ultrasonic sensors, proximity sensors, light detection and ranging sensors (LIDAR), radar sensors, temperature sensors, wind sensors, light sensors, or any other sensor type useful for gathering data useful for the transport robot.

In various implementations, the body 383 may also include a transceiver 390 coupled with the robot controller. In various implementations, the transceiver may receive commands via telecommunication channel from a manual control device or from an automatic control system. In various transport robot implementations, the transport robot may operate autonomously, semi-autonomously, under manual control, or in any combination of the foregoing. In implementations that utilize various types of control, the commercial solar farm may have the end of each row mapped using global positioning system coordinates. In implementations where the system operates autonomously or semi-autonomously, the global positioning system sensor in the body 383 may be used to determine a global position system coordinate associated with the location of the transport robot and then the controller uses the global positioning system coordinate of the next row of solar panels to determine the course of the transport robot as it transports a cleaning robot from a first array of solar panels to a second array of solar panels. In implementations with manual control, a global position sensing coordinate of the transport robot may be used by the operator to determine when the transport robot has reached a known coordinate at the end of each array of solar panels while being driven remotely.

In places where the description above refers to particular implementations of cleaning systems and implementing components, sub-components, methods and sub-methods, it should be readily apparent that a number of modifications may be made without departing from the spirit thereof and that these implementations, implementing components, sub-components, methods and sub-methods may be applied to other cleaning systems.

What is claimed is:

1. A solar panel cleaning system comprising:
an extrusion frame;
a driver end coupled to a first side of the extrusion frame;
a battery end coupled to a second side of the extrusion frame;
a solar panel coupled to a largest planar surface formed by the extrusion frame, the solar panel electrically coupled with a battery comprised in the battery end, the battery electrically coupled with one or more motors and with a controller comprised in the driver end; and
one or more brushes coupled between the driver end and the battery end, an end of the one or more brushes coupled with the one or more motors;
wherein the driver end and the battery end are configured to couple with one of a track that extends on either side of one or more solar panels or with edges of the one or more solar panels.

2. The system of claim 1, wherein the one or more motors comprise a first motor and a second motor and the first motor is coupled to a drive wheel coupled with a drive axle configured to rotate thereby advancing the system along the track.

3. The system of claim 2, wherein the second motor is coupled with the end of the one or more brushes and configured to rotate the brush in a desired rotational direction as the system advances along the track, the brush configured to remove dirt from a surface of the one or more solar panels.

4. The system of claim 3, further comprising a sensor system, an infrared light source, and an ultraviolet source wherein the sensor system is configured to detect one or more defects in the one or more solar panels through sensing one of infrared light from the infrared light source, ultraviolet light from the ultraviolet light source, or any combination thereof.

5. The system of claim 1, further comprising one or more stop sensors in the driver end coupled with the controller.

6. The system of claim 1, wherein the one or more brushes are made of microfiber brushes.

7. The system of claim 1, wherein the system is configured to be movable to a track coupled with a second one or more solar panels different from the track that extends on either side of the one or more solar panels.

8. A solar panel cleaning system comprising:
a cleaning robot comprising:
an extrusion frame;
a driver end coupled to a first side of the extrusion frame;
a battery end coupled to a second side of the extrusion frame;
a solar panel coupled to a largest planar surface formed by the extrusion frame, the solar panel electrically coupled with a battery comprised in the battery end, the battery electrically coupled with one or more motors and with a cleaning robot controller comprised in the driver end; and
one or more brushes coupled between the driver end and the battery end, an end of the one or more brushes coupled with the one or more motors;
a transport robot comprising:
at least three wheels coupled with a body;
a transport and application arm coupled with the body;
a transport robot controller comprised in the body, the transport robot controller coupled with a battery coupled with one or more motors coupled with the at least three wheels; and
a solar panel coupled with the battery;
wherein the driver end and the battery end are configured to removably couple with a track that extends on either side of one or more solar panels; and
wherein the transport and application arm is configured to:
couple with the cleaning robot to remove the cleaning robot from a track coupled with a first array of solar panels;
remain coupled with the cleaning robot while the transport robot moves from a first array of solar panels to a second array of solar panels;
couple the cleaning robot with a track coupled with the second array of solar panels; and
release the cleaning robot.

9. The system of claim 8, wherein the transport robot further comprises a global positioning system sensor coupled with the transport robot controller.

10. The system of claim 9, wherein the transport robot controller is configured to use the global positioning system sensor and a global positioning system coordinate of the first array of solar panels and a global positioning system coordinate of the second array of solar panels in moving the transport robot to a position to couple the cleaning robot with the track coupled with the second array of solar panels.

11. The system of claim 8, further comprising a sensor array coupled to the body of the transport robot and with the transport robot controller.

12. The system of claim 8, wherein the cleaning robot comprises a docking structure coupled with one of the extrusion frame, the driver end, or the battery end where the docking structure is configured to engage with an end of the transport and application arm.

13. The system of claim 8, wherein the cleaning robot comprises a transceiver coupled with the transport robot controller, the transceiver configured to receive commands via a telecommunication channel from a manual control device.

14. The system of claim 8, wherein the cleaning robot comprises a transceiver coupled with the transport robot controller, the transceiver configured to receive commands via a telecommunication channel from an automatic control system.

15. A cleaning system comprising:
two guide rails configured to couple on opposing sides of a solar tracking solar panel array;
a first retaining frame configured to couple at a first end of the movable solar panel array, the first end oriented perpendicularly with the two guide rails;
a second retaining frame configured to couple at a second end of the movable solar panel array, the second end opposing the first end;
a cleaning device housing comprising a weight, a brush, and at least one roller rotationally coupled with an end of the brush, the at least one roller configured to couple with the two guide rails;
wherein the cleaning device housing is configured to slide under only gravity force across a largest planar surface of the movable solar panel array when the solar tracking solar panel array reaches a critical orientation relative to a ground surface each day;
wherein the brush is configured to remove dirt from the largest planar surface as the device housing slides across the largest planar surface; and
wherein the cleaning device housing is retained by either the first retaining frame or the second retaining frame by gravity force when not sliding across the largest planar surface of the movable solar panel array.

16. The system of claim 15, further comprising wheels coupled at each end of the at least one roller that coupled into the two guide rails.

17. The system of claim 15, wherein the system comprises no motor.

18. The system of claim 15 wherein the weight is a weighted bar.

19. The system of claim 15, wherein the brush is a microfiber brush.

20. The system of claim 15, comprising three rollers coupled rotationally with the brush via a rubberized gear.
